(19) United States
(12) Patent Application Publication
(10) Pub. No.: US 2010/0283602 A1
(43) Pub. Date: Nov. 11, 2010

(54) System and method for monitoring relative position of moving object

(75) Inventors: Chi-Sheng Tsai, Taipei City (TW); Wang-Gen Chen, Taipei City (TW)

Correspondence Address: Chi-Sheng, Tsai, P.O. Box 46-563 Taipei, Taipei City, 10499, TW

(73) Assignees: PAN-AMERICA HYPERBARICS INC., Taipei City (TW); Rebit Digital Company Ltd, Taipei City (TW)

(21) Appl. No.: 12/387,814

(22) Filed: May 8, 2009

(51) Int. Cl. G08B 5/22

(52) U.S. Cl. 340/539.13

(57) ABSTRACT

Disclosed are a system and a method for monitoring a relative position of a moving object. The system essentially includes at least one positioning and transmitting device and a signal receiving and processing device, each equipped with a radio frequency identification (RFID) signal transceiver. The RFID signal transceiver of the signal receiving and processing device receives radio signals transmitted by the RFID signal transceiver of each of the positioning and transmitting devices, thus enabling the signal receiving and processing device to track one or more moving objects each carrying one such positioning and transmitting device and determine the position or positions of the one or more moving objects relative to the signal receiving and processing device.

### BACKGROUND OF THE INVENTION

1. Technical Field

The present invention relates to a system and a method for monitoring a relative position of a moving object. More particularly, the present invention relates to a system for continuously monitoring a specific moving object.

2. Description of Related Art

As the society we live in gradually becomes an aging one, cases of missing senior citizens who suffer from the Alzheimer's or other diseases are increasing. On the other hand, many parents are too busy at work to keep their children company and therefore lose track of their kids. Consequently, young children get lost, run away from home, or, even worse, are lured and abducted by fraud organizations. Hence, in order to prevent any regret, it is of utmost importance for caregivers to know the whereabouts of persons being taken care of. Given today's technological advancements, particularly in the field of mobile communications, it has been common practice to give cell phones with numbers specially applied for to young children or senior people so as to know their current conditions by making phone calls whenever necessary. However, while verbal communication can be conveniently established with cell phones, it is the young children or seniors themselves that are responsible for reporting their present locations. Therefore, in cases where they have no ideas as to where they are, such as when they lose directions in a mountain area, search or rescue operations cannot be started immediately. Nowadays, search or rescue operations are generally carried out in the following manner. First, the parents or relatives of the lost persons report to the police so that the police obtain from the cell phone service providers the location at which the lost persons made phone calls. Then, the police work with a rescue team to search for the missing persons according to the information provided by the cell phone service providers. As the aforesaid process is time-consuming and may delay the rescue operations, it is desirable to have a system capable of providing an alarm as soon as a person being attended to moves beyond a predetermined range, so as to relieve the caregiver of much trouble and worry.

Commercially available monitor systems typically incorporate Global Positioning System (GPS) into GSM or 3G mobile communication technology so that when a person being monitored changes position, the GPS receives satellite signals and sends out a calculated result of the person's location to a specific receiver through mobile communication. Taiwan Patent No. M287479 proposes a remote safety-guarding device comprising an input device, a response device, a signal transceiver, and a clock module. According to the disclosure of this Taiwan patent, a handheld digital device is configured to send out a current condition thereof to a monitor center at time points preset by a user, thus allowing the monitor center to take proper actions in response to the current condition received. However, the device disclosed in the aforesaid Taiwan patent cannot function where GSM or GPS signals are weak or unavailable. Furthermore, given the fact that people stay indoors most of the time, GPS will not work until the person being monitored or taken care of moves outdoors, which may be too late.

### BRIEF SUMMARY OF THE INVENTION

In view of the shortcomings of the existing monitor systems, the inventor of the present invention conducted extensive literature review and put years of relevant experience into the development of an improved monitor system. After repeated trials and modifications, a monitor system for continuously tracking a moving object is finally obtained and disclosed herein.

The primary objective of the present invention is to provide a system essentially including at least one positioning and transmitting device and a signal receiving and processing device, each provided with a radio frequency identification (RFID) signal transceiver. The signal receiving and processing device searches for the location or locations of the at least one positioning and transmitting device with a directional antenna and receives radio signals transmitted by the RFID signal transceiver of each positioning and transmitting device. Thus, the signal receiving and processing device is enabled to track one or more moving objects each carrying one such positioning and transmitting device and determine the position or positions of the one or more moving objects relative to the signal receiving and processing device.

A secondary objective of the present invention is to provide the foregoing system wherein each of the at least one positioning and transmitting device and the signal receiving and processing device is provided with a GPS signal receiver. When the at least one positioning and transmitting device and the signal receiving and processing device are both positioned outdoors and spaced apart beyond the receiving range of the RFID signal transceivers, the signal receiving and processing device determines the location or locations of one or more moving objects each carrying one such positioning transmitting device, as well as the distance or distances from the one or more moving objects to the signal receiving and processing device, via a known satellite positioning technique implemented through the GPS signal receivers.

Another objective of the present invention is to provide the foregoing system wherein one of the at least one positioning and transmitting device is in the form of a wristwatch to be worn conveniently by a patient or young child on the wrist so as to facilitate continuous tracking. Thereby, the accurate location of the patient or young child, as well as the distance therefrom to the positioning and transmitting device, can be continuously controlled.

A further objective of the present invention is to provide the foregoing system wherein the signal receiving and processing device may have its effective sensing distance set between 10 m and 100 m so that when the at least one positioning and transmitting device is spaced apart from the signal receiving and processing device by a distance greater than the effective sensing distance, a warning is provided via a sound alert or a voice warning generated by a sound generator of the signal receiving and processing device or via a sound alert played by a buzzer, or a light emitted by a flashing LED, of each positioning and transmitting device.

In addition to monitoring persons, the present invention is equally applicable to pets, and outdoor activities such as biking.

### BRIEF DESCRIPTION OF THE SEVERAL VIEWS OF THE DRAWINGS

The structure and the technical means adopted by the present invention to achieve the above and other objectives can be best understood by referring to the following detailed description of illustrative embodiments in conjunction with the accompanying drawings, wherein:

FIG. 1 is a block diagram of a system according to the present invention;

FIG. 2 is a block diagram of a positioning and transmitting device according to the present invention;

FIG. 3 is a block diagram of a signal receiving and processing device according to the present invention;

FIG. 4 is a perspective view of the positioning and transmitting device according to a preferred embodiment of the present invention;

FIG. 5 is a perspective view of the signal receiving and processing device according to the preferred embodiment of the present invention;

FIG. 6 is a perspective view of application of the preferred embodiment of the present invention;

FIG. 7 is another perspective view of application of the preferred embodiment of the present invention;

FIG. 8 is yet another perspective view of application of the preferred embodiment of the present invention;

FIG. 9 is still another perspective view of application of the preferred embodiment of the present invention;

FIG. 10 is a further perspective view of application of the preferred embodiment of the present invention;

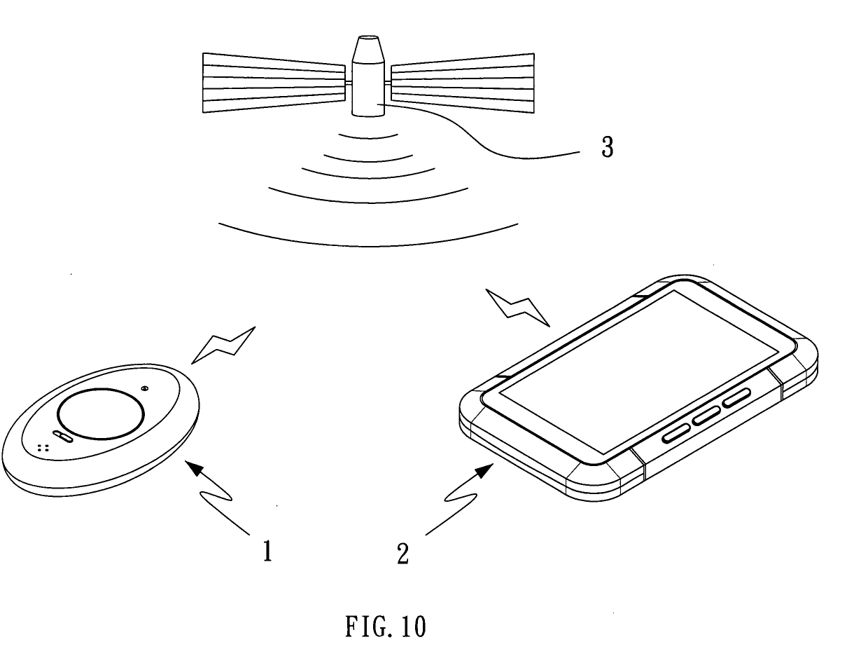

FIG. 11 is a perspective view of the positioning and transmitting device according to a second embodiment of the present invention;

FIG. 12 is a perspective view of application of the second embodiment of the present invention;

FIG. 13 is another perspective view of application of the second embodiment of the present invention;

FIG. 14 is a perspective view of application of a third embodiment of the present invention;

FIG. 15 is another perspective view of application of the third embodiment of the present invention; and

FIG. 16 is yet another perspective view of application of the third embodiment of the present invention.

### DETAILED DESCRIPTION OF THE INVENTION

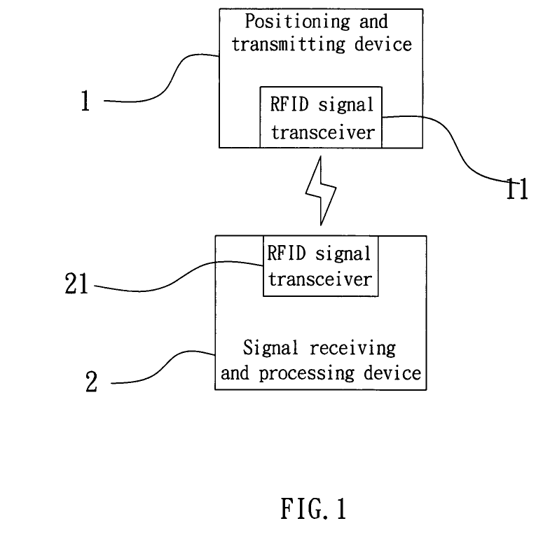

Please refer to FIGS. 1, 2, and 3 for a system block diagram and two partial block diagrams of the present invention. As shown in the drawings, a system according to the present invention essentially includes at least one positioning and transmitting device 1 and a signal receiving and processing device 2. The positioning and transmitting device 1 includes an RFID signal transceiver 11, a microcomputer controller 12, a timing device 121, a motion detector 122, a buzzer 123, a flashing LED 124, a signal modulating and decoding unit 125, a GPS signal receiver 13, a power supply end 14, a power supply voltage stabilizing unit 141, a power supply element 142, and a charging circuit 143, wherein the RFID signal transceiver 11 has an effective transmission distance of approximately 1Km. The signal receiving and processing device 2 includes an RFID signal transceiver 21, a directional antenna 211, a microcomputer controller 22, a timing device 221, an amplifier chip 222, a sound generator 223, an electronic compass 224, a control interface 225, an LCD device 226, a signal modulating and decoding unit 227, a GPS signal receiver 23, a power supply end 24, a power supply voltage stabilizing unit 241, and a power supply element 242. The directional antenna 211 only receives radio signals coming within a predetermined angular range, or propagating in a predetermined direction (such as a forward direction), of the antenna 211. Hence, the antenna 211 can be used to determine the transmission direction and intensity of an electronic signal in a way similar to the electronic tracking of wild animals.

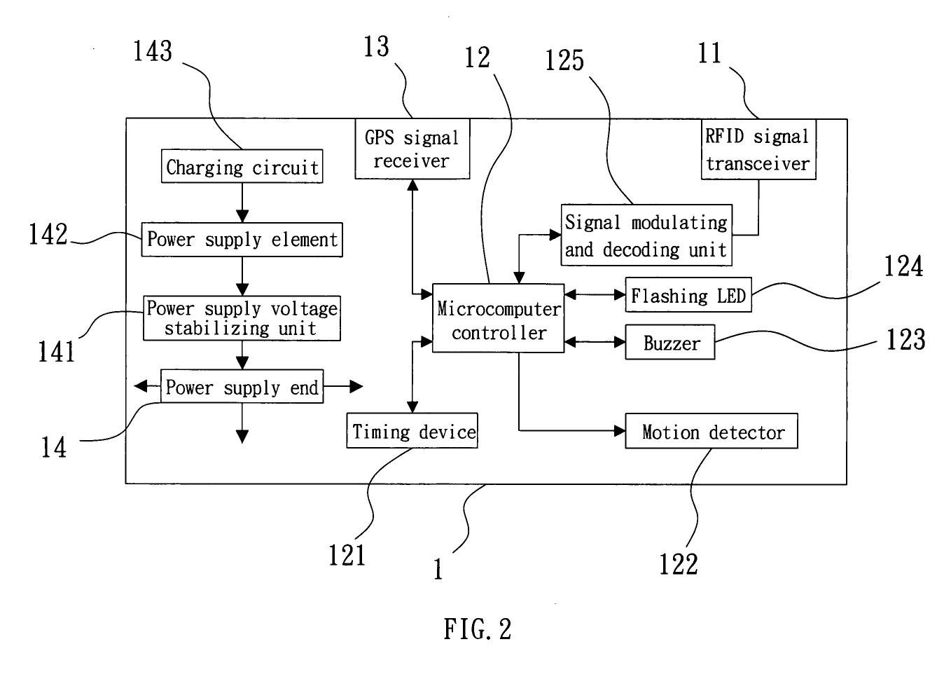

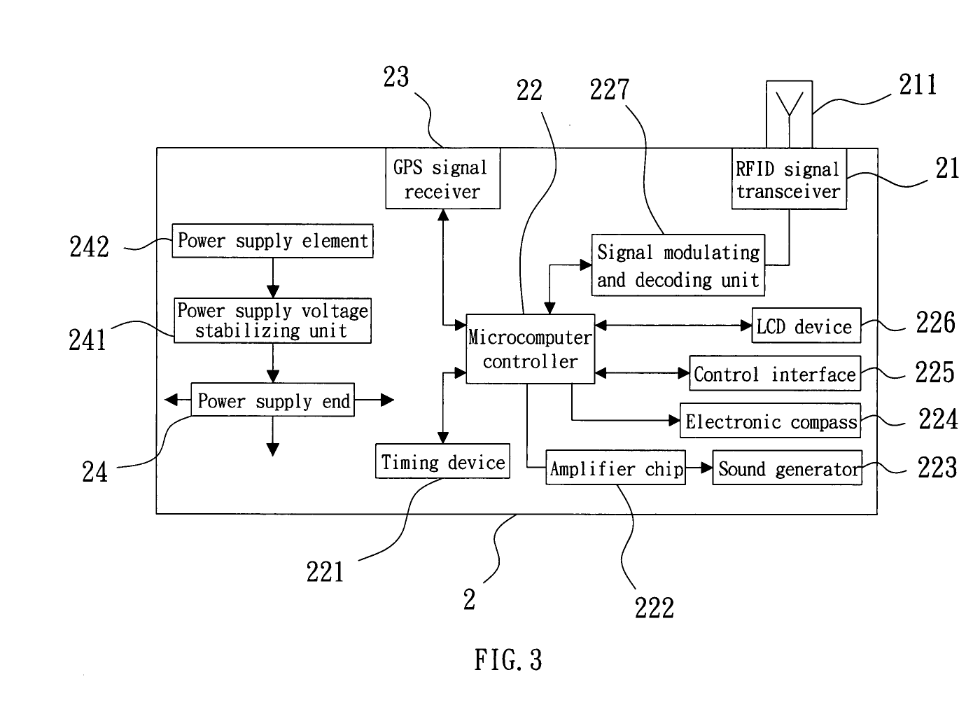

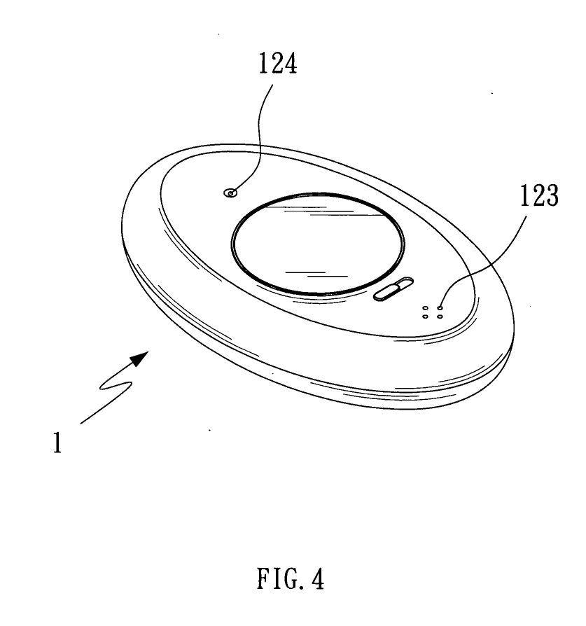

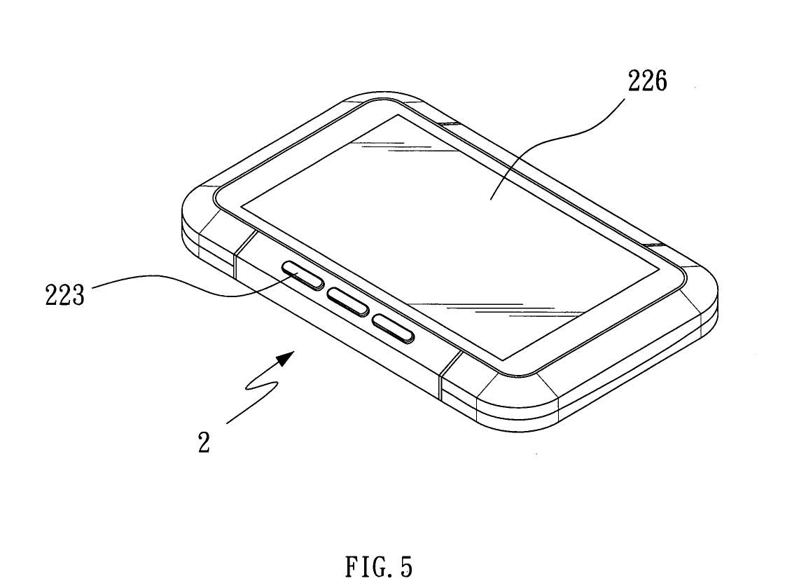

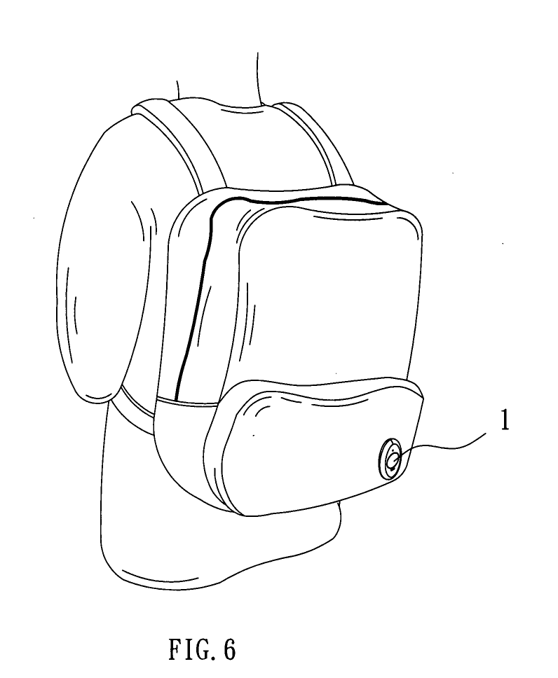

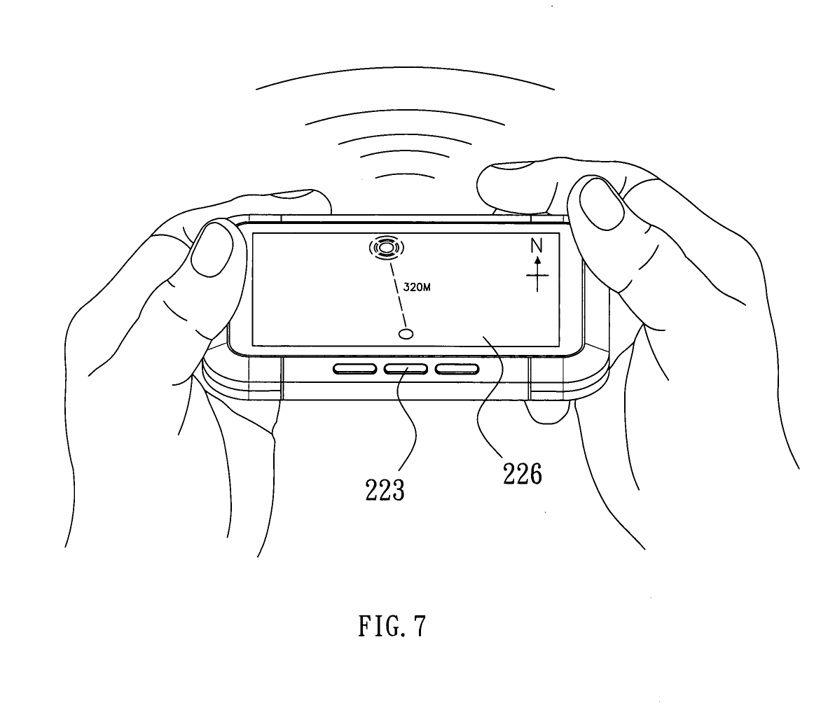

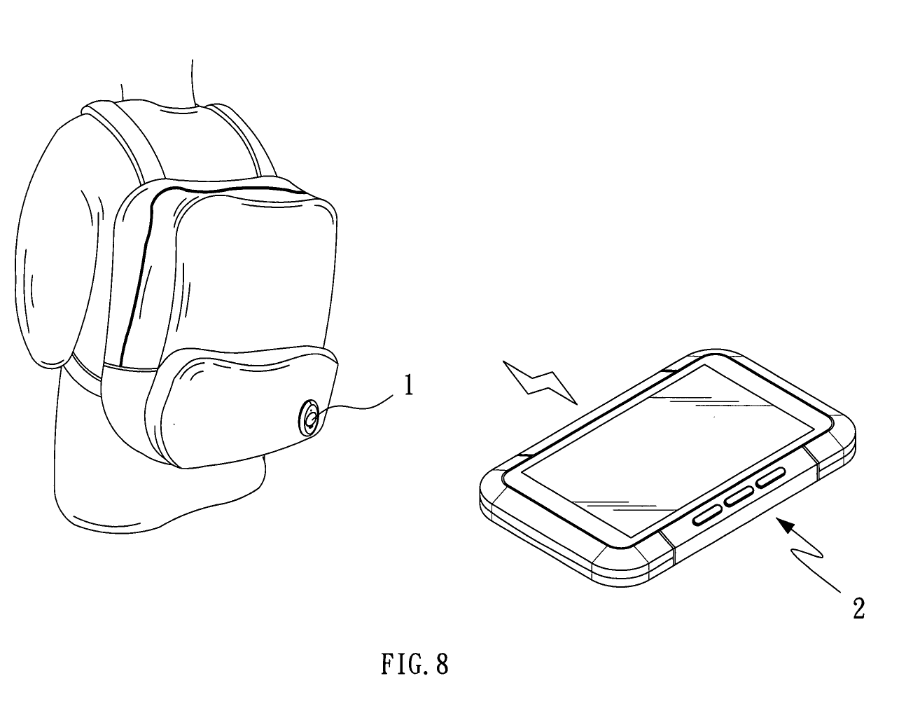

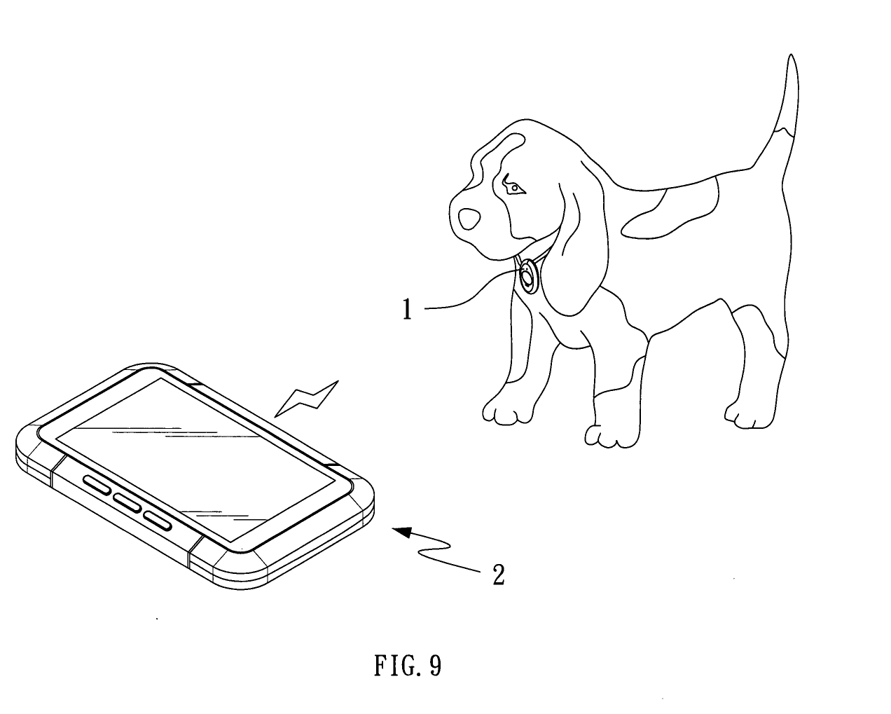

Reference is now made to FIGS. 4 through 9, in conjunction with FIGS. 2 and 3, for a preferred embodiment of the present invention wherein the positioning and transmitting device 1 is depicted as being carried by a child. When it is desired to search for the location of the child in an indoor environment, a user points the directional antenna 211 to a forward direction of the user and then rotates the signal receiving and processing device 2 so as to perform a 360-degree scan of the indoor environment until the directional antenna 211 picks up signals transmitted by the RFID signal transceiver 11 of the positioning and transmitting device 1. After receiving the signals transmitted by the RFID signal transceiver 11, the signal receiving and processing device 2 calculates, according to the intensity of the signals received, the accurate direction, position, and distance of the positioning and transmitting device 1 relative to the signal receiving and processing device 2. The LCD device 226 of the signal receiving and processing device 2 then indicates the actual location of the child by displaying the accurate direction, position, and distance of the positioning and transmitting device 1 relative to the signal receiving and processing device 2. (The searching procedure described above applies to all subsequent embodiments.) For the sake of convenience, the LCD device 226 may additionally display a direction indicator for indicating the degrees through which the signal receiving and processing device 2 has scanned. Upon completion of a 360-degree scan, the direction indicator displayed coincides with a mark representing the starting point of the 360-degree scan, and a sound alert is played to give notice to the user. An effective sensing distance of the signal receiving and processing device 2 is set between 10 m and 100 m so that, as soon as the positioning and transmitting device 1 is spaced apart from the signal receiving and processing device 2 by a distance greater than the effective sensing distance, the sound generator 223 of the signal receiving and processing device 2 generates a sound alert or a voice warning. Alternatively, once the distance between the positioning and transmitting device 1 and the signal receiving and processing device 2 exceeds the effective sensing distance, the buzzer 123 of the positioning and transmitting device 1 plays a sound alert, or the flashing LED 124 emits a light for warning. Thus, the user is informed that the child has moved beyond the effective sensing range, and immediate attention to the child's whereabouts is advised. The user can then follow the aforesaid searching procedure to find out the direction and distance of the child relative to the signal receiving and processing device 2 with the directional antenna 211.

The positioning and transmitting device 1 may also be attached to a pet so that the directional antenna 211 of the signal receiving and processing device 2 can be used (according to the aforesaid searching procedure) to determine the accurate direction, position, and distance of the pet relative to the signal receiving and processing device 2. In this case, the effective sensing distance of the signal receiving and processing device 2 may also be set between 10 m and 100 m so that immediately after the positioning and transmitting device 1 moves beyond the sensing range, the pet's owner is informed thereof via a sound alert or a voice warning generated by the sound generator 223 of the signal receiving and processing device 2 or, alternatively, via a sound alert played by the buzzer 123, or a light emitted by the flashing LED 124, of the positioning and transmitting device 1.

In order to save electricity, the motion detector 122 of the positioning and transmitting device 1 is configured to send out a signal to the microcomputer controller 12 if no motion has been detected within a predetermined period of time (such as five minutes). In response to the signal, the microcomputer controller 12 reduces the clock signals controlling system operation and lowers the frequency of signal transmission so as to cut down power consumption. On the other hand, if the motion detector 122 detects an increased frequency of motion, a corresponding signal is sent to the microcomputer controller 12 so as to raise the frequency of signal transmission and thereby enhance the monitoring accuracy. The motion detector 122 is a mercury switch or a metal ball capable of being displaced by inertia and thus making electrical connection with a nearby metal contact. The frequency of motion is determined by the frequency at which the motion detector 122 makes such electrical connection.

If the positioning and transmitting device 1 is positioned outdoors and beyond the effective sensing range, satellite positioning is implemented through the GPS signal receiver 13 provided in the positioning and transmitting device 1 and the GPS signal receiver 23 provided in the signal receiving and processing device 2 which receive signals transmitted by external satellites 3. Based on the radio signals received, the signal receiving and processing device 2 determines the accurate direction and position of the positioning and transmitting device 1 relative to the signal receiving and processing device 2. Therefore, whenever a child or a pet is missing, the accurate direction and position thereof relative to the signal receiving and processing device 2 can be figured out to facilitate searching. In addition, the microcomputer controller 22 of the signal receiving and processing device 2 is configured to store data including coordinates and moving paths of the positioning and transmission device 1 being tracked.

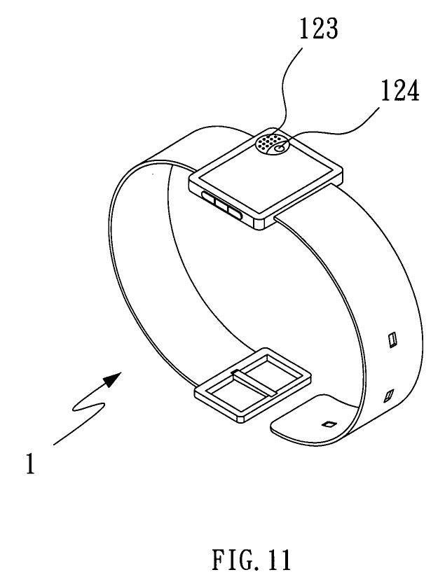

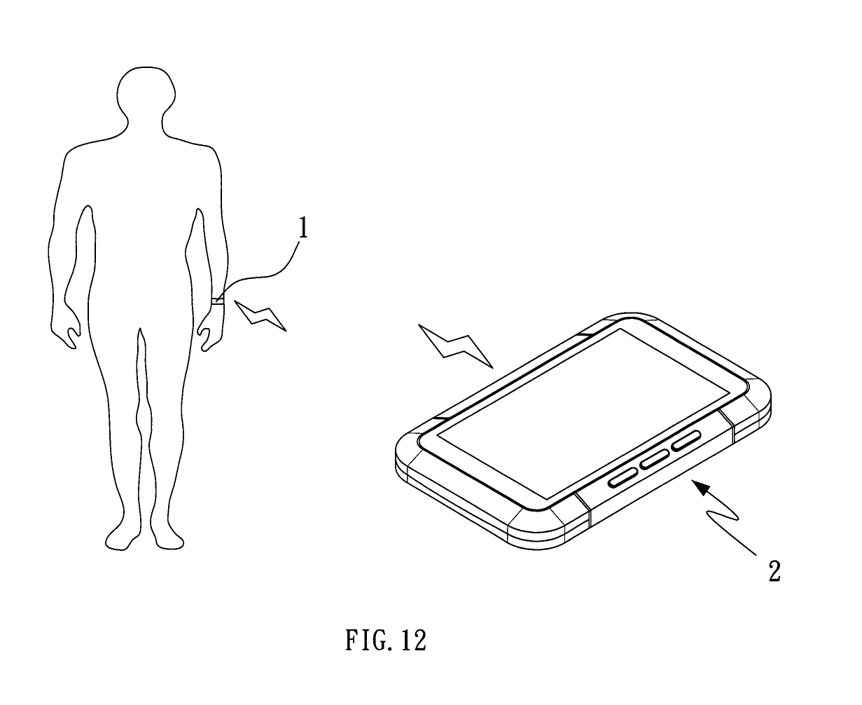

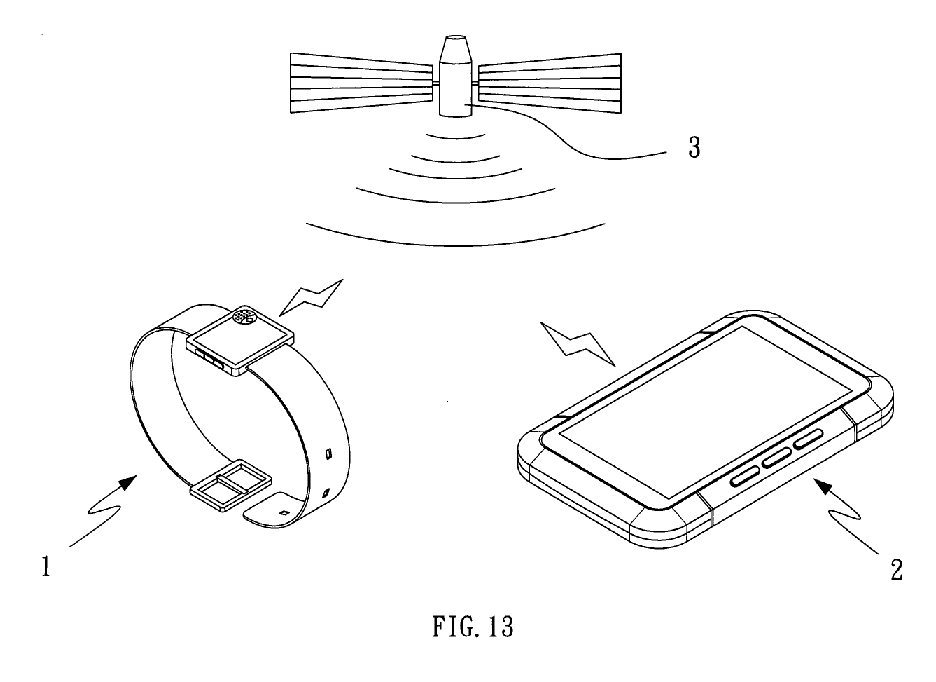

Please refer to FIGS. 11 through 13, in conjunction with FIGS. 2 and 3, for a second embodiment of the present invention. The positioning and transmitting device 1 shown in FIGS. 11 through 13 is provided in the form of a wristwatch so as for the positioning and transmitting device 1 to be easily worn on a patient's wrist. The indoor and outdoor use of the positioning and transmitting device 1 according to the second embodiment is the same as that described in the foregoing preferred embodiment and is not explained repeatedly herein.

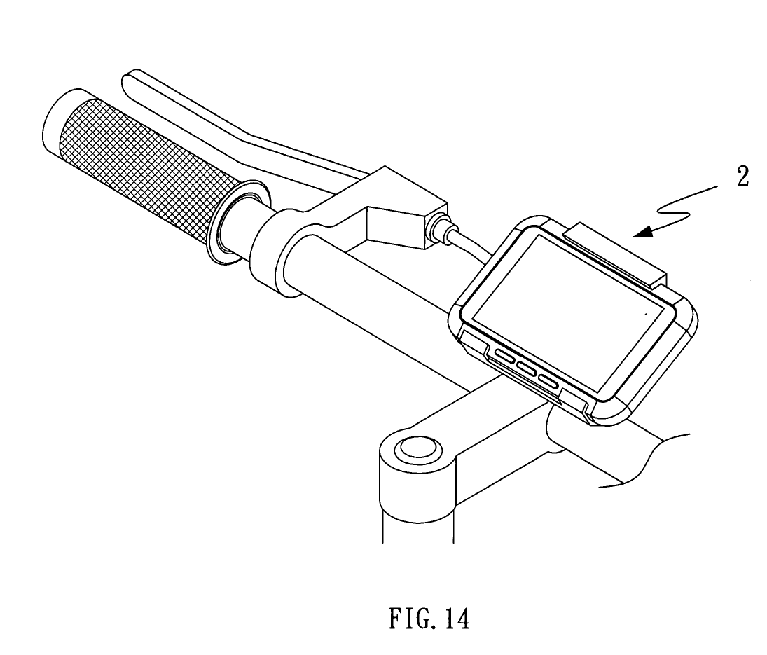

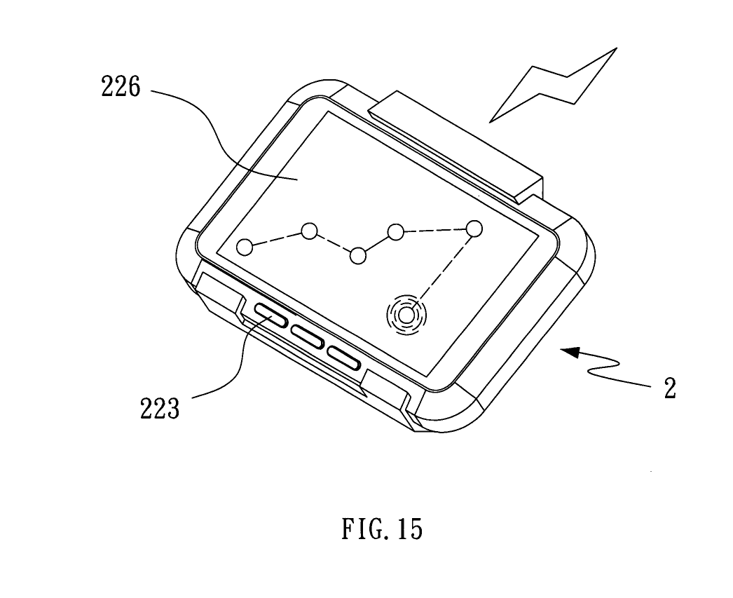

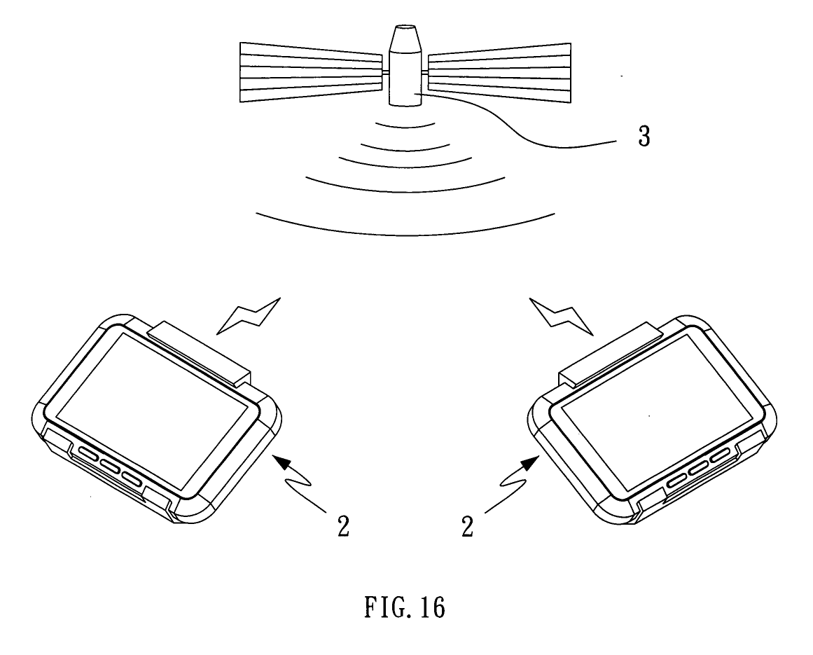

Referring to FIGS. 14 through 16, in conjunction with FIG. 3, for a third embodiment of the present invention, the signal receiving and processing device 2 is installed on a bicycle so as to be used in outdoor activities. The positioning function of external satellites 3 is carried out through the GPS signal receiver 23 of the signal receiving and processing device 2 so that the coordinates of the riding route of the bicycle are recorded to enable the provision of real-time location information and satellite navigation via the LCD device 226. When a plurality of bicycles are each equipped with the signal receiving and processing device 2, each signal receiving and processing device 2 is informed of the positions and distances of all the other signal receiving and processing devices 2 relative to itself through the positioning function of external satellites 3. Besides, data including coordinates and moving paths of the positioning and transmitting devices 1 being tracked are stored in the microcomputer controller 22 of each signal receiving and processing device 2. Additionally, the signal receiving and processing device 2 may be connected with a sports-type heart rate sensing device for monitoring the variation of a user's heart rate during outdoor activity.

In conclusion, the positioning and transmitting device 1 and the signal receiving and processing device 2 according to the present invention together form a monitor system fit for both indoor and outdoor applications. The RFID signal transceivers 11 and 21 provided in the devices 1 and 2, respectively, can sense each other so as to enable monitoring when the devices 1 and 2 are positioned indoors and within a predetermined signal transmitting and receiving range of the RFID signal transceivers 11 and 21. When the devices 1 and 2 are positioned outdoors and beyond the signal transmitting and receiving range of the RFID signal transceivers 11 and 21, monitoring is realized by the positioning function of external satellites 3 through the GPS signal receivers 13 and 23 provided in the devices 1 and 2, respectively. Therefore, the present invention uses both an RFID sensing technique and a GPS satellite positioning technique to continuously monitor a moving object without regard to the indoor/outdoor status, distance, and locations of the devices 1 and 2. Also, the signal receiving and processing device 2 is capable of simultaneously receiving signals from a plurality of the positioning and transmitting devices 1 so as to continuously monitor a plurality of moving objects at the same time.

1. A system for monitoring a relative position of a moving object, essentially comprising:
at least a positioning and transmitting device provided therein with a radio frequency signal transceiver and carried by a human being and a said moving object to be tracked; and
at least a signal receiving and processing device provided therein with a radio frequency signal transceiver and a directional antenna and configured for tracking a said moving object carrying a said positioning and transmitting device.

2. The system of claim 1, wherein each said positioning and transmitting device further comprises a microcomputer controller, a timing device, a motion detector, a buzzer, a flashing LED, a signal modulating and decoding unit, a power supply end, a power supply voltage stabilizing unit, a power supply element, and a charging circuit.

3. The system of claim 1, wherein each said signal receiving and processing device further comprises a microcomputer controller, a timing device, an amplifier chip, a sound generator, an electronic compass, a control interface, an LCD device, a signal modulating and decoding unit, a power supply end, a power supply voltage stabilizing unit, and a power supply element.

4. The system of claim 1, wherein each of the at least a positioning and transmitting device and the at least a signal receiving and processing device is provided with a GPS signal receiver.

5. The system of claim 4, wherein when a said positioning and transmitting device is positioned outdoors, a said signal receiving and processing device continuously monitors the moving object carrying the said positioning and transmitting device via a known GPS satellite tracking technique implemented through the GPS signal receiver of the said positioning and transmitting device and the GPS signal receiver of the said signal receiving and processing device.

6. The system of claim 1, wherein a said positioning and transmitting device is provided in form of a wristwatch so as to be easily worn on a user's wrist.

7. The system of claim 1, wherein a said signal receiving and processing device has an effective sensing distance set approximately between 10 m and loom.

8. The system of claim 1, wherein each said signal receiving and processing device is capable of receiving signals from a plurality of said positioning and transmitting devices.

9. A method for monitoring a relative position of a moving object, applicable to the system of claim 1 and characterized by scanning for a signal with a directional antenna when at least a positioning and transmitting device and at least a signal receiving and processing device are positioned in an indoor environment where a known GPS satellite positioning technique is inapplicable, the method comprising steps of:
pointing the directional antenna to a forward direction of a user;
scanning the indoor environment with a said signal receiving and processing device through 360 degrees until the directional antenna picks up a signal transmitted by a radio frequency signal transceiver of a said positioning and transmitting device;
determining a direction and a distance of the said positioning and transmitting device relative to the said signal receiving and processing device according to intensity of the signal transmitted by the radio frequency signal transceiver of the said positioning and transmitting device; and
displaying the direction and the distance on a display device.
